(19) United States
(12) Patent Application Publication
(10) Pub. No.: US 2005/0165717 A1
(43) Pub. Date: Jul. 28, 2005

(54) Method, system and computer program product for redirecting a response to a file request from a requesting communication program to a mail server

(75) Inventors: Vijaylaxmi Chakravarty, Austin, TX (US); Oltea Mihaela Herescu, Austin, TX (US); Claudia Andrea Salzberg, Austin, TX (US); Robert Lee Snider, Cedar Park, TX (US)

Correspondence Address: BRACEWELL & PATTERSON, L.L.P., P.O. BOX 969, AUSTIN, TX, 78767-0969, US

(73) Assignee: International Business Machines Corp., Armonk, NY (US)

(21) Appl. No.: 10/763,081

(22) Filed: Jan. 22, 2004

(51) Int. Cl. G06F 7/00

(52) U.S. Cl. 707/1

(57) ABSTRACT

A method, system and computer program product for improving efficiency of file receipt in a communication program by redirecting a file received as the result of a file request to a mail server is disclosed. A communication program sends a request for a first file to a file server. The communication program then waits a length of time to receive that first file. If the set length of time for waiting for the first file expires before the first file is received, the user interface of the communications program is released to request additional files while a background process waits for the first file. Then, once the background process receives the first file, the background process encapsulates the first file in a message and transmits the message to a target address.

### BACKGROUND OF THE INVENTION

1. Technical Field

The present invention relates in general to data processing and in particular to improving efficiency of file receipts in a communication program. Still more particularly, the present invention relates to a system, method and computer program product for improving efficiency of a file receipt in a communication program by redirecting a file received as the result of a file request to a mail server.

2. Description of the Related Art

The advent of widely distributed, interoperable, packetized data processing networks has transformed many aspects of commerce and information distribution. At the point of sale, this revolution has allowed transactions to be conducted instantaneously, at any time of the day or night, by persons separated by thousands of miles. Similarly, the marketplace of ideas has been revolutionized.

From the flash distribution of an announcement such as a press release, to the archival storage and querying of millions of pages on electronic data storage systems, users have become accustomed to receiving in seconds data that previously took days or weeks to reach the user. Prior methods of information storage and retrieval involved cumbersome manual search processes through multi-volume index references, travel to distant places where written records could be stored in bulk, and hours and hours of time invested in the reproduction of paper copies.

Now, through the advent of the Internet, and in particular the World Wide Web, the user of information can perform complex queries through remote search engines, while sitting thousands of miles from a place where records are physically stored. After the results of these queries are completed, digital copies can then be sent to the user of information almost instantaneously. The user of information can then select which records need to be reproduced, and the entire process can be undertaken without ever having to leave the user's desk to visit a dusty file room.

For all of the convenience and power in record retrieval from massive databases, problems exist in the use of particularly large bodies of information. One problem inherent in complex queries of large databases is the amount of time required to process queries and sort through the records represented in a database to obtain results. With particularly large databases, many of which may involve millions of records, each record containing scores of pages of information and diagrams, a query of the database can, depending on network traffic and allocation of resources, take anything from several minutes to more than half of an hour.

In an age when information is expected instantaneously, these wait times prove to be a great source of frustration, delay, and cost to the users of information. The problem posed by waiting time during the execution of complex online queries represents one of the single greatest and most costly annoyances in the retrieval of electronic records. Currently, alternatives to waiting are extremely limited. If a user wants to pursue other surfing, the user is forced to open a new browser window for the new surfing task and repeatedly check the old window to see if a response to a query has arrived.

The present invention recognizes that, to conserve user time and/or to reduce a user's annoyance, a method, system and computer program product for improving efficiency of a file receipt in a communications program is needed.

### SUMMARY OF THE INVENTION

A method, system and computer program product for improving efficiency of a file receipt in a communication program by redirecting a file received as the result of a file request to a mail server is disclosed. A communication program sends a request for a first file to a file server. The communication program then waits a length of time to receive that first file. If the set length of time for waiting for the first file expires before the first file is received, the user interface of the communications program is released to request additional files while a background process waits for the first file. Then, once the background process receives the first file, the background process encapsulates the first file in a message and transmits the message to a target address.

A preferred embodiment includes detecting whether a user prefers to continue waiting for receipt of the file or to redirect the file received as the result of the request. Additionally, the length of time on which the communications program will wait can be configurably fixed. Further, one or more designated email addresses can be designated as the target address for the message transmission.

The present invention can be embodied on a variety of communication program platforms including a hypertext browser, and the first file that is received can be a file of any of the several available markup languages, or a plain text file.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a data processing system in a network environment, in which a preferred embodiment of the method, system and computer program product for improving efficiency of file receipt are implemented;

FIG. 2A depicts a graphical user interface for ascertaining user preferences in accordance with a preferred embodiment of the present invention;

FIG. 2B depicts a graphical user interface for communicating information to a user in accordance with a preferred embodiment of the present invention; and

FIG. 3 is a high-level logical flowchart of a process for improving efficiency of file receipt in a communication program by redirecting a hypertext transfer protocol (HTTP) query to a simple mail transfer protocol (SMTP) server.

### DETAILED DESCRIPTION OF ILLUSTRATIVE EMBODIMENT(S)

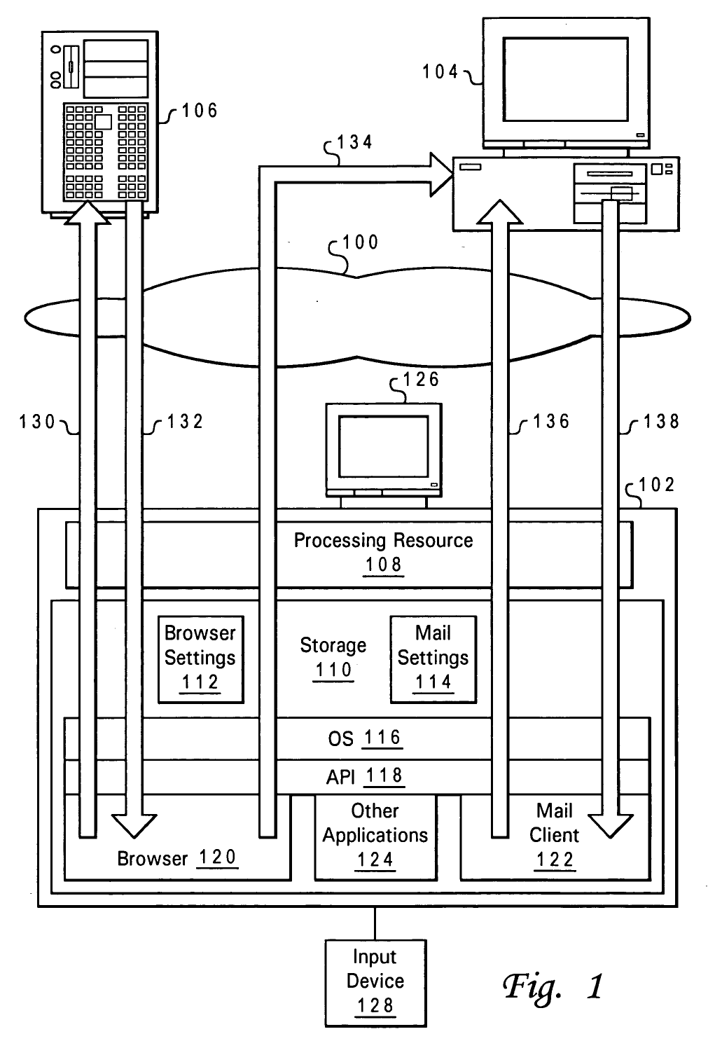

With reference now to the figures and in particular with reference to FIG. 1, there is depicted an exemplary network environment, with which the present invention may be advantageously utilized. The illustrated network environment includes a local or wide area network 100, such as the Internet or another packetized digital network. A client data processing system 102, a mail server 104 (e.g., a simple mail transfer protocol (SMTP) and Post Office Protocol 3 (POP3) or Internet Message Access Protocol (IMAP) server), and a file server 106 (e.g., a hypertext transfer protocol (HTTP) server) are attached to network 100.

Mail server 104 performs functions related to the sending and receiving of electronic mail messages. File server 106 retrieves and delivers files across network 100. Mail server 104 and file server 106 may both be implemented with conventional or later developed hardware or software.

Client data processing system 102 includes a processing resource 108 for performing data processing functions and a storage unit 110 for storing items of data or instructions for use by processing resource 108. Storage unit 110 may be implemented as a Random Access Memory (RAM) or as another form of storage, such as a dynamic access storage device. As illustrated, storage unit 110 stores operating system (OS) 116, application program interface (API) 118, browser 120, mail client 122, and optionally other applications 124. Storage unit 110 also stores browser settings 112 and mail settings 114. Client data processing system 102 also includes a display device 126 and an input device 128, such as a keyboard or mouse. As will become quickly apparent to one skilled in the art, although a preferred embodiment of the present invention is illustrated and described with respect to browser 120, the present invention can be implemented on a variety of file retrieval programs without departing from the scope of the present invention.

The present invention improves efficiency of file receipt in a communication program, such as browser 120, by redirecting to a mail server a file received as the result of a file request. This is accomplished through the use of several messages, which are sent and received by client data processing system 102. As depicted in FIG. 1, client data processing system 102 transmits a file request 130, which originates from browser 120 and is delivered to file server 106 via network 100 by application program interface 118 and operating system 116 on client data processing system 102. File request 130 will typically be an HTTP get request, such as a query to a web server's search engine. In response to file request 130, file server 106 transmits a response 132 to client data processing system 102 via network 100. Response 132 will typically contain one or more files responsive to the get request of file request 130, and these files can include a web page, a hit list, an image, an install file, an applet, or some other file fitting the request. Response 132 is received by browser 120 from application program interface 118 and operating system 116.

Client data processing system 102 transmits an outgoing mail message 134, which contains files received by browser 120 in response 132 to mail server 104. Outgoing mail message 134 originates from browser 120 and is delivered to network 100 by application program interface 118 and operating system 116 on client data processing system 102. The files of interest are thus buffered at mail server 104 until mail client 122 requests the files of interest through a mail request 136.

In an alternative embodiment of the present invention, browser 120 could contain a unit of data processing instructions for sending response 132 to mail client 122, which could then send an outgoing mail message to mail server 104. In another alternative embodiment of the present invention, browser 120 could contain a unit of data processing instructions for sending response 132 to mail client 122, which could result in mail client 122 creating a simulated incoming message in the inbox of mail client 122.

Returning to the preferred embodiments, when the user desires to view the files, the user invokes mail client 122, if mail client 122 is not already activated. Responsive to a command to check mail, client data processing system 102 transmits a mail request 136, which originates from mail client 122 and is delivered to network 100 by application program interface 118 and operating system 116 on client data processing system 102, to mail server 104. Mail server 104 responds to mail request 136 by transmitting an inbound mail message 138 from mail server 104 to mail client 122 on data processing system 102 by way of application program interface 118 and operating system 116 on client data processing system 102. Inbound mail message 138 contains files received by browser 120 as part of response 132 and sent by browser 120 as part of outgoing mail message 134.

As is illustrated in a simplified form in FIG. 1, the preferred embodiment of the present invention provides a method, system, and computer program product for freeing browser 120 resources by redirecting response 132, which was originally sent to browser 120 in response to file request 130, to mail server 104 as part of outgoing mail message 134. Client data processing system 102 can then retrieve response 132 from mail server 104 by sending mail request 136 to mail server 104 and receiving inbound mail message 138. After browser 120 sends outgoing mail message 134 to mail server 104, resources belonging to browser 120 can be freed for additional file requests and receipts.

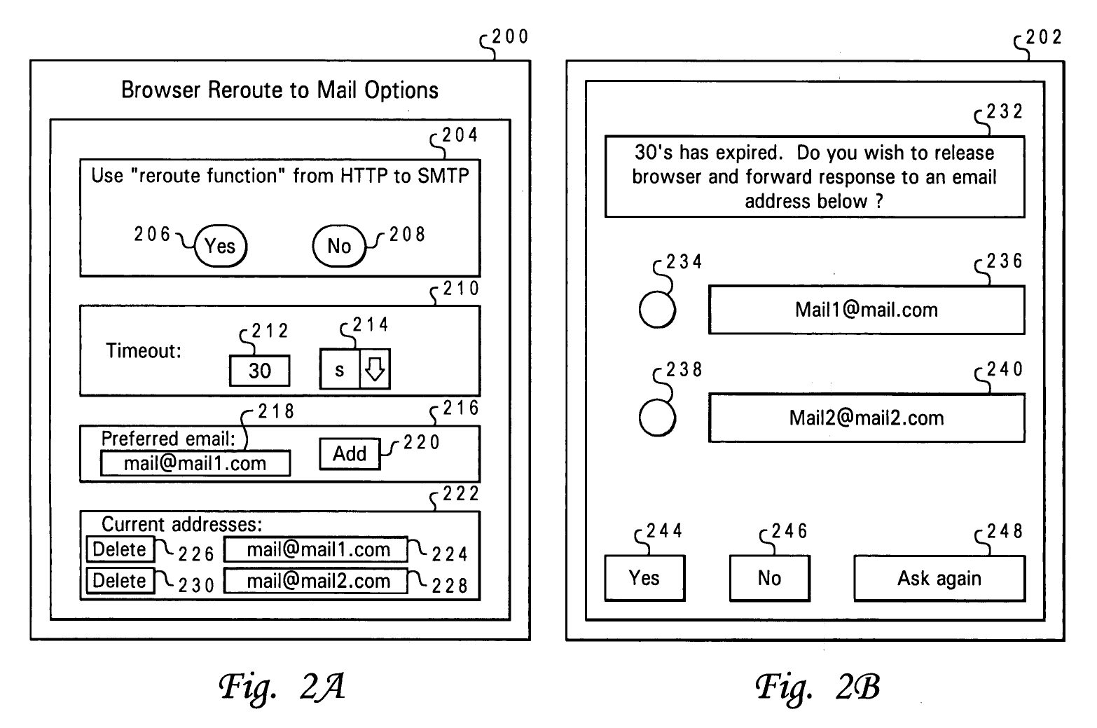

Referring now to FIG. 2A, there is depicted a diagram presenting a user preferences graphical user interface (GUI) 200 of browser 120 for ascertaining user preferences in accordance with a preferred embodiment of the present invention. Information on user preferences, received through the use of user preferences GUI 200 is stored in browser settings 112 of storage unit 110 on data processing system 102.

As illustrated, user preferences GUI 200 contains an activation query box 204. Activation query box 204 prompts the user to indicate whether the user wishes to configure browser 120 to redirect high-latency responses, sent in response to file requests by browser 120, to mail server 104. In the particular embodiment illustrated as activation query box 104, the user is asked whether the user desires to “Use reroute function from HTTP to SMTP?” Thus, in one embodiment the user has the option of routing a hypertext transfer protocol (HTTP) response to a simple mail transfer protocol (SMTP) server. Other embodiments may implement this rerouting by using other servers and protocols.

The user responds to the query contained in activation query box 204 by checking one of ‘yes’ radio button 206 and ‘no’ radio button 208. A second query box, timeout query box 210, allows the user to indicate the timeout length, which specifies how long browser 120 will wait to receive response 132 before presenting user prompt GUI 202 of FIG. 2B. Timeout query box 210 provides a numerical input field 212 and a unit input field 214. Numerical input field 212 is utilized to set the number of units of time that browser 120 will wait to receive response 132 before presenting user prompt GUI 202. Units field 214 gives the unit of time to be associated with numerical input field 212. During operation of browser 120, browser 120 may vary the timeout length specified in timeout query box 210 in response to a task priority of browser 120. That is, where a browser window is not selected as the foreground task running on data processing system 102, browser 120 may lengthen or shorten a timeout length.

Input email query box 216 permits the user to input an email address, to which browser 120 may selectably redirect response 132. Input email query box 216 provides an email field 218 and an add button 220. When an email address is entered in email field 218 and add button 220 is selected, the email address listed in email field 218 is presented within current addresses list box 222. Current addresses list box 222 contains a listing of email addresses to which a response may be sent, as well as means for deleting addresses from current addresses list box 222. As illustrated in FIG. 2A, current addresses list box 222 contains a first address 224 accompanied by a delete button 226. Current addresses list box 222 also contains a second address 228 accompanied by a second delete button 230. Selection of first delete button 226 or second delete button 230 deletes the associated one of first address 224 and second address 228 from current addresses list box 222. Current addresses list box 222 will expand or contract according to the number of targeted email addresses added to current email addresses list box 222 through the use of input email query box 216.

FIG. 2B depicts an exemplary user prompt GUI 202 displayed by browser 120 to a user to indicate whether the user desires to re-route a response to a particular file request to a mail server. User prompt GUI 202 contains a prompt/query message 232 that is displayed to inform the user that the timeout period specified in timeout query blank 210 has expired and to query whether the user desires to forward response 132 to one of the email addresses listed in current addresses list box 222. As illustrated in FIG. 2B, user prompt GUI 202 contains a first radio button 234 for selecting first email address 236 and a second radio button 238 for selecting second email address 240 as a target of a forwarded response. Additionally, permission to proceed with forwarding is indicated by actuation of ‘yes’ button 244. A lack of permission is indicated by actuation of ‘no’ button 246, and a desired additional delay is indicated by actuation of ‘ask again’ button 248.

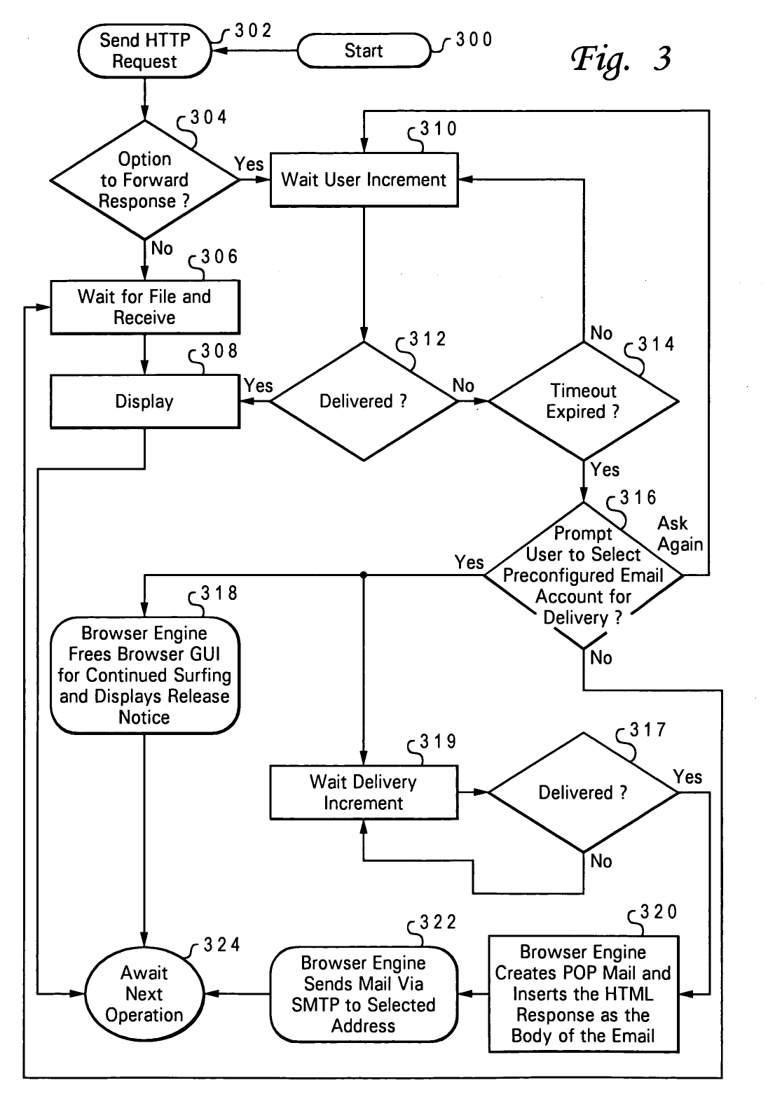

With reference now to FIG. 3, there is depicted a high-level logical flowchart of a process for improving the efficiency of file receipt in a communication program by redirecting a response to a HTTP query to a SMTP server. The process begins at step 300, which depicts activation of browser 120 of client data processing system 102. The process then proceeds to step 302, which illustrates browser 120 transmitting file request 130 to file server 106 across network 100. File request 130 will typically be an HTTP get request, such as a query to a web server's search engine or a request for a particular web page associated with a specified URL. The process next moves to step 304, which depicts browser 120 on client data processing system 102 detecting whether an option to forward response 132 to mail server 104 has been activated through user preferences GUI 200.

If the option to forward response 132 from file server 106 to mail server 104 has not been selected, the process then proceeds to step 306, which depicts client data processing system 102 waiting for and receiving response 132. Once data processing system 102 receives response 132, the process next moves to step 308, which depicts data processing system 102 displaying response 132 or a portion thereof on display device 126. Displaying response 132 on display device 126 will typically mean that browser 120 translates an HTML file for presentation on display device 126, though displaying response 132 on display device 126 could easily include other operations, including, for example, the execution of a program executable delivered over the web. The process then proceeds to step 324, which depicts data processing system 102 waiting for the user or another stimulus to initiate a next operation.

Returning to block 304, if the option to forward response 132 to mail server 104 is detected, the process next moves to step 310, which depicts data processing system 102 waiting during a period, called a user increment, for receipt of response 132. The user increment is a length of time, separate from and generally shorter than, but potentially identical to the amount of time provided in response to timeout query 210. Browser 120 may temporarily and dynamically adjust the user increment in response to a task priority of browser 120. That is, where a browser window is not selected as the foreground task running on data processing system 102, browser 120 may lengthen or shorten a user increment. The process then proceeds to step 312, which depicts browser 120 detecting whether browser 120 has received response 132 from file server 106 over network 100.

If, in step 312, browser 120 detects that response 132 has been delivered to data processing system 102, then the process next proceeds to step 308, and the process proceeds as previously described with respect to step 308 and step 324.

If, in step 312 browser 120 detects that response 132 has not been received, then the process next proceeds to step 314, which depicts browser 120 determining whether the interval specified in response to timeout query 210 has expired. If the interval specified in response to timeout query 210 has not expired, then the process next proceeds to step 310, which depicts data processing system 102 waiting during a period, called a user increment, for receipt of response 132 as previously detailed.

If, in step 314, browser 120 determines that the interval specified in response to timeout query 210 has expired, then the process next proceeds to step 316, which depicts browser 120 prompting the user to select a preconfigured email account for delivery through presentation of a prompt, such as user prompt GUI 202, on display device 126. When display device 126 presents user prompt GUI 202, the user is presented with three options, as described with respect to FIG. 2B. If the user selects ‘no’ button 246 with input device 128 to indicate a lack of permission, the process then proceeds to step 306, which depicts client data processing system 102 waiting for and receiving response 132. Once data processing system 102 receives response 132, the process next moves to step 308, which depicts data processing system 102 displaying response 132 on display device 126, as described above. If the user indicates a desire to defer a decision to redirect a response by actuation of ‘ask again’ button 248, the process next moves to step 310, which depicts data processing system 102 waiting during a period, called a user increment, for receipt of response 132, as described above.

If the user actuates ‘yes’ button 244 within user prompt GUI 202, the process depicted in FIG. 3 bifurcates, representing the execution of two separate threads. The first thread begins at step 318, which depicts browser 120 freeing the graphical user interface on display device 126 for continued file retrieval. As a part of step 318, browser 120 presents a release notice over display device 126 or another notification. This release notification informs the user that a background process will receive response 132, and that the user is being returned to normal web surfing without the need to open a new browser window and manually poll for the receipt of response 132. The browsing experience is substantially enhanced as the user can now turn attention to other matters while the background process waits for the file.

Additionally, a second background process, depicted in steps 319, 317, 320 and 322, begins in step 319. Step 319 depicts browser 120 waiting a delivery increment. After waiting a delivery increment, the process next proceeds to step 317, which depicts browser 120 on client data processing system 102 detecting whether response 132 has been delivered to browser 120.

If response 132 has not been delivered to browser 120, then browser 120 again proceeds back to step 319 to wait for the expiration of another delivery increment. If, in step 317, browser 120 detects receipt of response 132 from file server 106, then the process next moves to step 320, which depicts browser 120 creating outgoing mail message 134 and inserting response 132 into outgoing mail message 134. Response 132 can be inserted into outgoing mail message 134 by a variety of methods, including without limitation encapsulating an HTML file into the text of the message and attaching an HTML file, supporting files, executables, or a JPG representation of an HTML file to outgoing mail message 134. The process next moves to step 322, which illustrates browser 120 sending outgoing mail message 134 to mail server 104. The process then proceeds to step 324, wherein data processing system 102 awaits a next operation. In step 322, the background process of steps 319, 317, 320 and 322 completes and terminates after sending outgoing mail message 134, though termination may not be readily discernable to the user because no new window was opened for the background process.

As has been described, the present invention provides an improved user experience in web browsing or other file viewing and retrieval activities by enabling the user to continue normal file viewing and retrieval while a background process waits to receive high-latency files and forward such files to a mail server. The user can then, at his leisure, query an email server with an email client to retrieve delayed files. Delivery to an email server in this manner also facilitates storage and portability of requested files.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

1. A method for improving efficiency of file receipt in a communication program, comprising:
sending a request for a first file from a communication program;
waiting a length of time for a receipt of said first file;
responsive to said length of time expiring before said receipt occurs, releasing a user interface of said communication program to request additional files while a background process waits for said first file; and
in response to receipt of said first file with said background process, encapsulating said first file in a message transmission and sending said message transmission to a target address.

2. The method of claim 1, further comprising, responsive to said length of time expiring before said receipt occurs, detecting whether a user prefers to continue waiting for said receipt.

3. The method of claim 1, further comprising setting said length of time in response to a configuration input.

4. The method of claim 1, further comprising designating an email address as said target address.

5. The method of claim 1, further comprising adjusting said length of time in response to a task priority of said communication program.

6. The method of claim 1, wherein said sending step further comprises sending from a hypertext browser.

7. The method of claim 1, wherein said sending step further comprises sending a request for a first file, which is a markup language file.

8. A system for improving efficiency of file receipt in a communication program, comprising:
means for sending a request for a first file from a communication program;
means for waiting a length of time for a receipt of said first file;
means for, responsive to said length of time expiring before said receipt occurs, releasing a user interface of said communication program to request additional files while a background process waits for said first file;
means for receiving said first file with said background process;
means for encapsulating said first file in a message transmission; and
means for sending said message transmission to a target address.

9. The system of claim 8, further comprising means for, responsive to said length of time expiring before said receipt occurs, detecting whether a user prefers to continue waiting for said receipt.

10. The system of claim 8, wherein said means for waiting a length of time for a receipt of said first file further comprise means for configurably fixing said length of time.

11. The system of claim 8, further comprising means for designating an email address as said target address.

12. The system of claim 8, further comprising means for comprising adjusting said length of time in response to a task priority of said communication program.

13. The system of claim 8, wherein said communication program is a hypertext browser.

14. The system of claim 8, wherein said first file is a markup language file.

15. A computer program product in a computer-readable medium for improving efficiency of file receipt in a communication program, comprising:
a computer-readable medium;
instructions on the computer readable medium for sending a request for a first file from a communication program;
instructions on the computer readable medium for waiting a length of time for a receipt of said first file;
instructions on the computer readable medium for, responsive to said length of time expiring before said receipt occurs, releasing a user interface of said communication program to request additional files while a background process waits for said first file;
instructions on the computer readable medium for receiving said first file with said background process;
instructions on the computer readable medium for encapsulating said first file in a message transmission; and instructions on the computer readable medium for sending said message transmission to a target address.

16. The computer program product of claim 15, further comprising instructions on the computer readable medium for, responsive to said length of time expiring before said receipt occurs, detecting whether a user prefers to continue waiting for said receipt.

17. The computer program product of claim 15, wherein said instructions for waiting a length of time for a receipt of said first file further comprise instructions on the computer-readable medium for configurably fixing said length of time.

18. The computer program product of claim 15, further comprising instructions on the computer-readable medium for designating an email address as said target address.

19. The computer program product of claim 15, further comprising instructions on the computer-readable medium for comprising adjusting said length of time in response to a task priority of said communication program.

20. The computer program product of claim 15, wherein said communication program is a hypertext browser.

21. The computer program product of claim 15, wherein said first file is a markup language file.

22. A data processing system for improving efficiency of file receipt, said data processing system comprising:
a processing resource; and
a storage unit coupled to said processing resource, said storage unit storing a communication program that, responsive to receipt of a response to a file request after expiration of a specified interval following the file request, automatically forwards said response to a specified network address upon receipt.
